(19) United States
(12) Patent Application Publication
(10) Pub. No.: US 2026/0356601 A1
(43) Pub. Date: Nov. 12, 2026

(54) MATERIAL STORAGE SYSTEM, SUCTION DEVICE AND CONTROL METHOD FOR MATERIAL STORAGE SYSTEM

(71) Applicants: JIANGSU XCMG CONSTRUCTION MACHINERY RESEARCH INSTITUTE LTD., Xuzhou, Jiangsu (CN); JIANGSU XCMG STATE KEY LABORATORY TECHNOLOGY CO., LTD., Xuzhou, Jiangsu (CN)

(72) Inventors: Haiqiang LI, Xuzhou, Jiangsu (CN); Yang LI, Xuzhou, Jiangsu (CN); Xiumei ZHU, Xuzhou, Jiangsu (CN); Wen ZHENG, Xuzhou, Jiangsu (CN)

(21) Appl. No.: 19/113,091

(22) PCT Filed: Nov. 24, 2023
(86) PCT No.: PCT/CN2023/134005

§ 371 Date: Mar. 19, 2025

(30) Foreign Application Priority Data
Nov. 10, 2023 (CN) 202311499110.2

(51) Int. Cl. B65G 53/66; B65G 53/28; B65G 53/36; B65G 53/50; B65G 53/56

(52) U.S. Cl. CPC B65G 53/66; B65G 53/28; B65G 53/36; B65G 53/50; B65G 53/56

(57) ABSTRACT

A material storage system, a suction device and a control method for a material storage system, the material storage system comprising: a material storage mechanism configured to receive-material; a feed distribution mechanism configured to selectively communicate the feeding port with the first hopper or the second hopper; an uploading mechanism configured to selectively switch between an opening of the first hopper and an opening of the second hopper; and a processor configured to switch the material storage mechanism between a first working state and a second working state through the feed distribution mechanism and the uploading mechanism, so that in the first working state, the material storage mechanism configured to receive material through the first hopper and unload the material through the second hopper, and in the second working state, the material storage mechanism configured to receive material through the second hopper and unload the material through the first hopper.

### CROSS-REFERENCE TO RELATED APPLICATIONS

This disclosure is a U.S. National Stage Application under 35 U.S.C. § 371 of International Patent Application No. PCT/CN2023/134005, filed on Nov. 24, 2023, which is based on and claims priority to Chinese Patent Application No. 202311499110.2, filed on Nov. 10, 2023, both of which are hereby incorporated by reference in their entireties.

### FIELD OF THE INVENTION

The present disclosure relates to the field of emergency rescue machinery, in particular to a material storage system, a suction device and a control method for a material storage system.

### BACKGROUND OF THE INVENTION

The land area in China is very vast, but is mostly mountains and hills, accounting for 69% of the total land area. Domestic geological disasters occur frequently, and mainly include four mountain disasters of landslides, collapses, mudslides and land subsidence. The sudden geological disasters cause serious casualties and economic losses. In the process of on-site rescue, it is not suitable for the construction of large earthwork machinery such as excavators and loaders in narrow spaces and occasions where people are buried. Instead, materials need to be sucked away by using a high negative pressure suction principle through digging and suction trucks, so as to improve the efficiency of on-site material cleaning and minimize the secondary injury of people.

In the related art, a material storage tank of the suction truck is limited in volume, but the suction efficiency is usually higher, and the material storage tank will be filled up soon, and then needs to be stopped, unloaded and restarted. Since the materials are sucked into the material storage tank by negative pressure, a hopper door of the conventional material storage tank needs to be opened during unloading. At this time, the pressure in the material storage tank is the same as external atmospheric pressure, and a suction system cannot form a negative pressure. As a result, the material cannot be sucked into the material storage tank. In the rescue process where time is life, the time spent by stopping and unloading operations of the suction truck greatly affects the rescue efficiency at a rescue site.

### SUMMARY OF THE INVENTION

In view of this, embodiments of the present disclosure provide a material storage system, a suction device and a control method for a material storage system, which can improve the suction efficiency.

In one aspect of the present disclosure, a material storage system for a suction device is provided and includes:
a material storage mechanism having a first hopper and a second hopper, and configured to receive material through a feeding port;
a feed distribution mechanism arranged on a material conveying path between the material storage mechanism and the feeding port, and configured to selectively communicate the feeding port with the first hopper or the second hopper, so that the first hopper or the second hopper receives material through the feeding port;
an uploading mechanism operatively connected with the first hopper and the second hopper, and configured to selectively switch between the opening of the first hopper and an opening of the second hopper, so that the first hopper or the second hopper is capable of uploading material; and
a processor in signal connection with the feed distribution mechanism and the uploading mechanism, and configured to switch the material storage mechanism between a first working state and a second working state through the feed distribution mechanism and the uploading mechanism, so that in the first working state of the material storage mechanism, the material storage mechanism configured to receive the material through the first hopper and unload the material through the second hopper, and in the second working state of the material storage mechanism, the material storage mechanism configured to receive the material through the second hopper and unload the material through the first hopper.

In some embodiments, the material storage system further includes:
a material level detection mechanism arranged in the material storage mechanism and configured to obtain material levels in the first hopper and the second hopper;
wherein the processor is in signal connection with the material level detection mechanism and configured to operate the material storage mechanism in the first working state or the second working state according to at least one of the material level of the first hopper and the material level of the second hopper.

In some embodiments, the material storage mechanism is configured to exhaust gas through a gas outlet;
wherein the material storage system further includes:
an outlet gas diverting mechanism arranged on a gas flow path between the material storage mechanism and the gas outlet, and configured to selectively communicate the gas outlet with the first hopper or the second hopper, so that the first hopper or the second hopper is configured to exhaust gas through the gas outlet;
wherein the processor is in signal connection with the outlet gas diverting mechanism, and is configured to communicate the gas outlet with the first hopper through the outlet gas diverting mechanism in the first working state of the material storage mechanism, so as to form a negative pressure in the first hopper, and to communicate the gas outlet with the second hopper through the outlet gas diverting mechanism in the second working state of the material storage mechanism, so as to form the negative pressure in the second hopper.

In some embodiments, the feed distribution mechanism includes:
a first feeding portion for being communicated with the feeding port;
a first uploading portion communicated with the first hopper;
a second uploading portion communicated with the second hopper;
a first shunting portion arranged between the first feeding portion and the first uploading portion and between the first feeding portion and the second uploading portion; and
a first rotating plate assembly arranged in the first shunting portion and configured to rotating relative to at least one of the first uploading portion and the second uploading portion;
wherein the processor is in signal connection with the first rotating plate assembly, and is configured to control the rotation of the first rotating plate assembly, so as to communicate the first feeding portion with the first uploading portion to receive the material by the first hopper, or communicate the first feeding portion with the second uploading portion to receive the material by the second hopper.

In some embodiments, the first hopper is not in communication with the second hopper.

In some embodiments, the first hopper and the second hopper are separated by a partition plate with a mounting hole;
wherein the feed distribution mechanism includes:
a second feeding portion communicating with the feeding port;
a first flap assembly arranged at the mounting hole, located downstream of the second feeding portion, and the first flap assembly configured to turn over between the first hopper and the second hopper relative to the mounting hole to close the first hopper and guide the material to the second hopper, or close the second hopper and guide the material to the first hopper; and
a fifth driving member arranged between the partition plate and the first flap assembly;
wherein the processor is in signal connection with the fifth driving member and is configured to make the first flap assembly turn over to the first hopper through the fifth driving member, so that the first hopper receives the material or is turned over to the second hopper, so that the second hopper receives the material.

In some embodiments, the uploading mechanism includes at least one of the following:
a first unloading plate, rotatably connected with the first hopper as a hopper door of the first hopper, to open the first hopper for unloading or closing the first hopper;
a second unloading plate, rotatably connected with the second hopper as a hopper door of the second hopper, to open the second hopper for unloading or closing the second hopper.

In some embodiments, the uploading mechanism further includes at least one of the following:
a first driving member connected between the inner wall of the first hopper and the first unloading plate;
a second driving member connected between the inner wall of the second hopper and the second unloading plate;
wherein the processor is in signal connection with at least one of the first driving member and the second driving member, and is configured to open the first hopper or the second hopper through at least one of the first driving member and the second driving member, so that the first hopper or the second hopper unloads the material.

In some embodiments, the uploading mechanism further includes at least one of the following:
a first material pushing plate rotatably connected with the first hopper as a bottom plate of the first hopper, so as to push the material in the first hopper out of the first hopper;
a second material pushing plate rotatably connected with the second hopper as a bottom plate of the second hopper, so as to push the material in the second hopper out of the second hopper.

In some embodiments, wherein the material storage system configured to be at least one of the following:
the first material pushing plate, and the first unloading plate are connected by a first connector, and the first material pushing plate is configured to rotate along with rotation of the first unloading plate; and
the second material pushing plate, and the second unloading plate are connected by a second connector, and the second material pushing plate is configured to rotate along with rotation of the second unloading plate.

In some embodiments, wherein the material storage system configured to be at least one of the following:
a length of the first connector is adjustable, so that when the first unloading plate is in a position of closing the hopper door of the first hopper, the first material pushing plate seals the bottom of the first hopper; and
a length of the second connector is adjustable, so that when the second unloading plate closes the hopper door of the second hopper, the second material pushing plate closes the bottom of the second hopper.

In some embodiments, the uploading mechanism further includes at least one of the following:
a first material guiding plate arranged at the outer side of the first hopper, rotatably connected with the bottom of the first hopper, and configured to guide the material in the first hopper to be unloaded along the first material guiding plate; and
a second material guiding plate arranged at the outer side of the second hopper, rotatably connected with the bottom of the second hopper, and configured to guide the material in the second hopper to be unloaded along the second material guiding plate.

In some embodiments, the uploading mechanism further includes at least one of the following:
a third driving member connected between the bottom of the first hopper and the first material guiding plate; and
a fourth driving member connected between the bottom of the second hopper and the second material guiding plate;
wherein the processor is in signal connection with the third driving member and the fourth driving member and is configured to switch a material guiding angle of the first material guiding plate through the third driving member and a material guiding angle of the second material guiding plate through the fourth driving member.

In some embodiments, the material storage system further includes:
a material dispersion mechanism arranged in the material storage mechanism, and having a mounting portion and a rotating portion, wherein the mounting portion is connected with the material storage mechanism, the rotating portion is rotatably connected with the mounting portion, the rotating portion has a plurality of blanking holes arranged at intervals, and the material dispersion mechanism is configured to enable the material from the feeding port to fall dispersedly in the material storage mechanism.

In another aspect of the present disclosure, a suction apparatus is provided and includes:
any material storage system as described above.

In yet another aspect of the present disclosure, a control method for a material storage system is provided and includes:
switching a material storage mechanism between a first working state and a second working state through a feed distribution mechanism and an uploading mechanism;
wherein in the first working state of the material storage mechanism, the material storage mechanism receives material through a first hopper and unloads the material through a second hopper, and in the second working state of the material storage mechanism, the material storage mechanism receives the material through the second hopper and unloads the material through the first hopper.

In some embodiments, the material storage system further includes:
a material level detection mechanism arranged at the material storage mechanism and configured to obtain material levels in the first hopper and the second hopper;
wherein the operation of switching the material storage mechanism between the first working state and the second working state through the feed distribution mechanism and the uploading mechanism specifically includes:
obtaining the material level in the first hopper and the material level in the second hopper through the material level detection mechanism; and
in response to the material level in the first hopper being greater than a preset material level, switching the material storage mechanism to the second working state, and in response to the material level in the second hopper being greater than the preset material level, switching the material storage mechanism to the first working state.

In some embodiments, the material storage mechanism can exhaust gas through a gas outlet;
wherein the material storage system further includes:
an outlet gas diverting mechanism arranged on a gas flow path between the material storage mechanism and the gas outlet, and configured to selectively communicate the gas outlet with the first hopper or the gas outlet with the second hopper, so that the first hopper or the second hopper exhausts gas through the gas outlet;
wherein the control method for a material storage system further includes:
in the first working state of the material storage mechanism, communicating the gas outlet with the first hopper through the outlet gas diverting mechanism, so that a negative pressure is formed in the first hopper, and in the second working state of the material storage mechanism, communicating the gas outlet with the second hopper through the outlet gas diverting mechanism, so that a negative pressure is formed the second hopper.

Therefore, according to the embodiments of the present disclosure, the first hopper and the second hopper independently open and close feeding channels and the hopper doors respectively, during feeding of the first hopper, the material accumulated in the second hopper can be unloaded at the same time, and when the material in the first hopper are full and need to be unloaded, the second hopper can be switched to a feeding state, so that the first hopper is unloaded and the second hopper is fed with the material at the same time. The material storage mechanism can allow a material storage operation and an unloading operation to be carried out at the same time, the material storage and unloading states can be switched without a need to stop the device during working hours, thereby improving the working efficiency and saving the rescue time.

### BRIEF DESCRIPTION OF THE DRAWINGS

The accompanying drawings, which form portion of the description, illustrate embodiments of the present disclosure and together with the description, serve to explain the principles of the present disclosure.

The present disclosure can be more clearly understood from the following detailed descriptions with reference to the accompanying drawings, in which:

FIG. 1 is a perspective view according to some embodiments of a material storage system of the present disclosure;

FIG. 2 is a front view according to some embodiments of a material storage system of the present disclosure;

FIG. 3 is a side view according to some embodiments of a material storage system of the present disclosure;

FIG. 4 is a connection relationship diagram according to some embodiments of a material storage system of the present disclosure;

FIG. 5 is a perspective view of a feed distribution mechanism according to some embodiments of a material storage system of the present disclosure;

FIG. 6 is a schematic diagram of an internal structure of a feed distribution mechanism according to some embodiments of a material storage system of the present disclosure;

FIG. 7 is a schematic diagram of an internal structure of a feed distribution mechanism according to some other embodiments of a material storage system of the present disclosure;

FIG. 8 is a perspective view according to some other embodiments of a material storage system of the present disclosure;

FIG. 9 is a schematic structural diagram of a first flap assembly according to some embodiments of a material storage system of the present disclosure;

FIG. 10 is a structural perspective view of a material dispersion mechanism according to some embodiments of a material storage system of the present disclosure;

FIG. 11 is a top view of a material dispersion mechanism according to some embodiments of a material storage system of the present disclosure;

FIG. 12 is a cross-sectional view of a material dispersion mechanism according to some embodiments of a material storage system of the present disclosure;

FIG. 13 is a schematic structural diagram according to some embodiments of a suction device of the present disclosure; and

FIG. 14 is a flowchart according to some embodiments of a control method for a material storage system of the present disclosure.

### IN THE FIGURES

1. material storage mechanism; 11. first hopper; 12. second hopper; 13. partition plate; 131. mounting hole; 2. feeding port; 3. feed distribution mechanism; 31. first feeding portion; 32. first uploading portion; 321. first pipeline; 33. second uploading portion; 331. second pipeline; 34. first shunting portion; 35. first rotating plate assembly; 351. first rotating plate; 352. second rotating plate; 353. third rotating plate; 354. rotating plate driving member; 36. second feeding portion; 37. first flap assembly; 371. flap; 372. sealing structure; 373. connecting hole; 38. fifth driving member; 4. uploading mechanism; 41. first unloading plate; 411. first driving member; 42. second unloading plate; 421. second driving member; 43. first material pushing plate; 431. first connector; 44. second material pushing plate; 441. second connector; 45. first material guiding plate; 451. third driving member; 46. second material guiding plate; 461. fourth driving member; 5. processor; 6. material level detection mechanism; 7. gas outlet; 8. outlet gas diverting mechanism; 81. first gas outlet portion; 82. first gas inlet portion; 83. second gas inlet portion; 84. second shunting portion; 85. second rotating plate assembly; 9. material dispersion mechanism; 91. mounting portion; 92. rotating portion; 921. blanking hole; 93. bearing.

It should be understood that the dimensions of various portions shown in the accompanying drawings are not drawn according to an actual scale relationship. In addition, the same or similar reference signs indicate the same or similar components.

### DETAILED DESCRIPTION OF THE EMBODIMENTS

Various exemplary embodiments of the present disclosure will now be described in detail with reference to the accompanying drawings. The descriptions of the exemplary embodiments are merely illustrative and are in no way intended to limit the present disclosure, and application or uses thereof. The present disclosure can be implemented in many different forms and is not limited to the embodiments described herein. These embodiments are provided, so that the present disclosure will be thorough and complete, and will fully convey the scope of the present disclosure to those skilled in the art. It should be noted that unless otherwise specified, the relative arrangement of components and steps, the composition of material, numerical expressions and numerical values set forth in these embodiments should be interpreted as merely illustrative and not as limitative.

Similar words of “first”, “second” and the like used in the present disclosure do not indicate any order, quantity or importance, but are only used to distinguish different portions. Similar words such as “including” or “containing” mean that the elements before the word cover the elements listed after the word, without excluding the possibility of covering other elements. “Upper”, “lower”, “left”, “right” and the like are only used to indicate a relative positional relationship. After the absolute position of a described object changes, the relative positional relationship may also change accordingly.

In the present disclosure, when it is described that a specific device is located between a first device and a second device, there may be an intervening device between the specific device and the first device or the second device or not. When it is described that the specific device is connected to other devices, the specific device may be directly connected to the other devices without the intervening device, and may also have the intervening device without being directly connected to the other devices.

All terms (including technical terms or scientific terms) used in the present disclosure have the same meanings as those understood by ordinary skilled in the art to which the present disclosure belongs, unless otherwise defined particularly. It should also be understood that the terms defined in, for example, general dictionaries should be interpreted as having the meanings consistent with their meanings in the context of the related art, and should not be interpreted in an idealized or extremely formal sense unless explicitly defined herein.

Technologies, methods and equipment known to those skilled in the related art may not be discussed in detail, but the technologies, methods and equipment should be regarded as portion of the description under appropriate circumstances.

The land area in China is very vast, but is mostly mountains and hills, accounting for 69% of the total land area. Domestic geological disasters occur frequently, and mainly include four mountain disasters of landslides, collapses, mudslides and land subsidence. The sudden geological disasters cause serious casualties and economic losses. In the process of on-site rescue, it is not suitable for the construction of large earthwork machinery such as excavators and loaders in narrow spaces and occasions where people are buried. Instead, material need to be sucked away by using a high negative pressure suction principle through digging and suction trucks, so as to improve the efficiency of on-site material cleaning and minimize the secondary injury of people.

In the related art, a material storage tank of the suction truck is limited in volume, but the suction efficiency is usually higher, and the material storage tank will be filled up soon, and then needs to be stopped, unloaded and restarted. Since the material are sucked into the material storage tank by negative pressure, a hopper door of the conventional material storage tank needs to be opened during unloading. At this time, the pressure in the material storage tank is the same as external atmospheric pressure, and a suction system cannot form a negative pressure. As a result, the material cannot be sucked into the material storage tank. In the rescue process where time is life, the time spent by stopping and unloading operations of the suction truck greatly affects the rescue efficiency at a rescue site.

In view of this, in one aspect of the embodiments of the present disclosure, a material storage system is provided for a suction device and can improve suction efficiency.

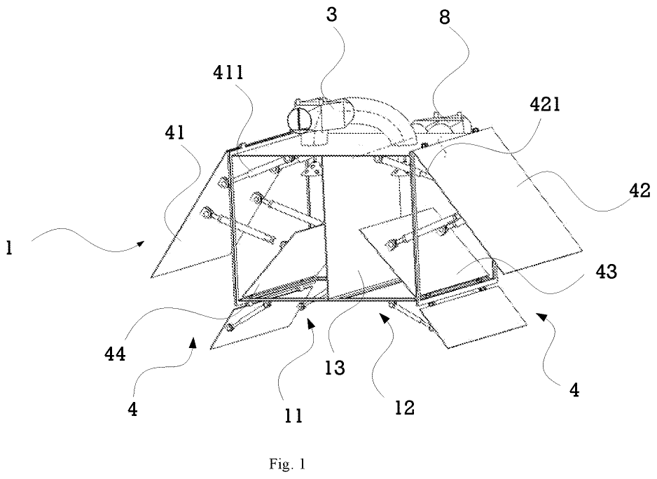

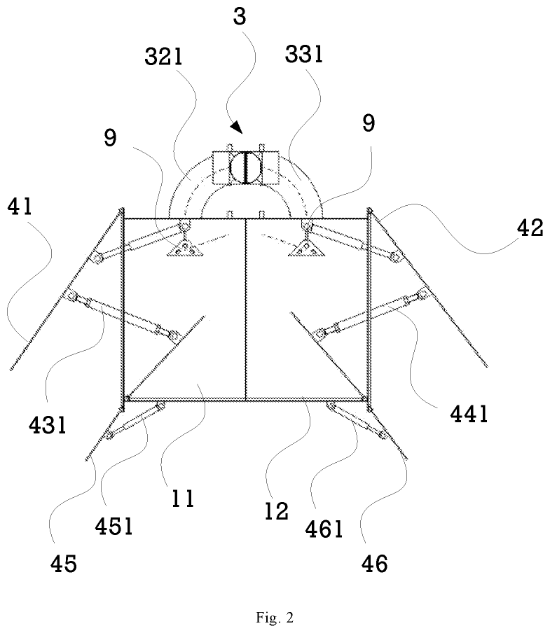

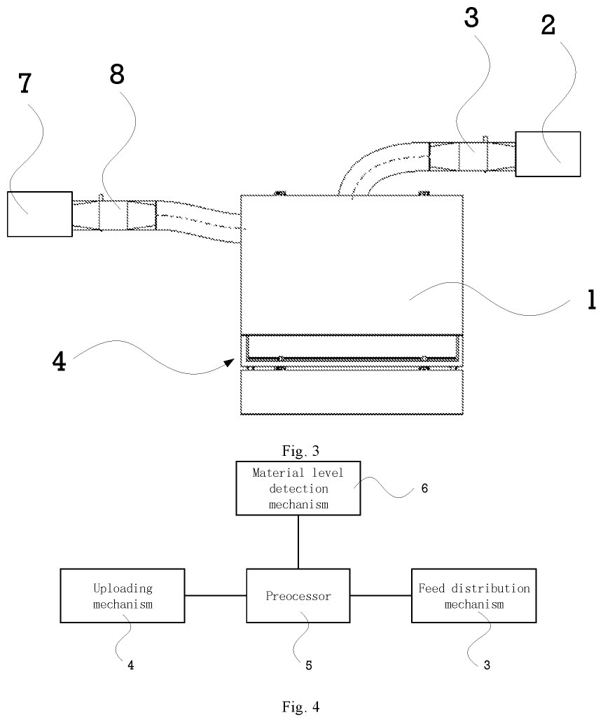

FIG. 1 is a perspective view according to some embodiments of a material storage system of the present disclosure, FIG. 2 is a front view according to some embodiments of the material storage system of the present disclosure, FIG. 3 is a side view according to some embodiments of the material storage system of the present disclosure, and FIG. 4 is a connection relationship diagram according to some embodiments of the material storage system of the present disclosure. Referring to FIGS. 1-4, the material storage system includes: a material storage mechanism 1, a feed distribution mechanism 3, an uploading mechanism 4 and a processor 5. The material storage mechanism 1 is used to temporarily store material such as dirt and mud stones sucked by the suction device. When the material storage mechanism 1 are full of the material, the temporarily stored material may be unloaded outwards from the material storage mechanism 1 through the uploading mechanism 4, so as to continue the suction operation.

The material storage mechanism 1 has a first hopper 11 and a second hopper 12. The material storage mechanism 1 is configured to receive the material through a feeding port 2 and suck the material into the first hopper 11 or the second hopper 12 for temporary storage. The material includes but are not limited to soil and dirt stones generated in mountain disasters such as landslides, collapses, mudslides and land subsidence.

It is included but not limited to that the first hopper 11 and the second hopper 12 are independently arranged, and the material storage mechanism 1 may also be divided into two hoppers, namely the first hopper 11 and the second hopper 12, by a partition plate 13. The first hopper 11 and the second hopper 12 may be bin bodies with the same capacity and size, and the capacity and size may also be set adaptively according to actual work requirements.

The feed distribution mechanism 3 is arranged on a material conveying path between the material storage mechanism 1 and the feeding port 2, and is configured to selectively communicate the feeding port 2 with the first hopper 11 or the second hopper 12, so as to open a feeding channel between the feeding port 2 and the first hopper 11 and close a feeding channel between the feeding port 2 and the second hopper 12, or open the feeding channel between the feeding port 2 and the second hopper 12 and close the feeding channel between the feeding port 2 and the first hopper 11, so that the first hopper 11 or the second hopper 12 receives the material through the feeding port 2.

The uploading mechanism 4 is operatively connected with the first hopper 11 and the second hopper 12, and is configured to selectively switch between the opening of the first hopper 11 and the opening of the second hopper 12, so that the first hopper 11 or the second hopper 12 uploads material. The uploading mechanism 4 may open or close hopper doors at unloading bin ports of the first hopper 11 and the second hopper 12, so as to unload the material in the first hopper 11 or the second hopper 12, or make the first hopper 11 or the second hopper 12 closed.

The processor 5 is in signal connection with the feed distribution mechanism 3 and the uploading mechanism 4, and is configured to switch the material storage mechanism 1 between a first working state and a second working state through the feed distribution mechanism 3 and the uploading mechanism 4, so that the first hopper 11 is configured to fed with the material and the second hopper 12 is configured to unloaded, or the first hopper 11 is configured to unloaded and the second hopper is configured to fed with the material, in order for that in the first working state of the material storage mechanism 1, the material storage mechanism 1 receives the material through the first hopper 11 and unloads the material through the second hopper 12, and in the second working state of the material storage mechanism 1, the material storage mechanism 1 receives the material through the second hopper 12 and unloads the material through the first hopper 11.

In the present embodiment, the first hopper 11 and the second hopper 12 independently open and close the feeding channels and independently open and close the hopper doors respectively, so that during the first hopper 11 is receiving material, the material accumulated in the second hopper 12 can be unloaded at the same time, and when the first hopper 11 is full of the material and need to be unloaded, the second hopper 12 can be switched to a feeding state, so that the first hopper 11 is unloaded while the second hopper 12 is receiving with the material. The material storage mechanism 1 can allow a material storage operation and an unloading operation to be carried out at the same time, and it is no need to stop the device and occupy working hours to switch the suction device between material storage state and unloading state, thereby improving the working efficiency and saving the rescue time.

Referring to FIG. 4, in some embodiments, the material storage mechanism further includes a material level detection mechanism 6, and the material level detection mechanism 6 is arranged in the material storage mechanism 1 and configured to obtain material levels in the first hopper 11 and the second hopper 12. It is included but not limited to that the material level detection mechanism 6 is arranged in the first hopper 11 and the second hopper 12.

The processor 5 is in signal connection with the material level detection mechanism 6, and is configured to operate the material storage mechanism 1 in the first working state or the second working state according to at least one of the material level of the first hopper 11 and the material level of the second hopper 12.

In the present embodiment, a material storage situation in the first hopper 11 and the second hopper 12 is monitored in real time by arranging the material level detection mechanism 6, so that when the material level in the first hopper 11 exceed a preset material level and the first hopper 11 is about to be full, the first hopper 11 is stopped from feeding, the first hopper 11 is switched to the unloading state and the second hopper 12 is changed to continue receiving the sucked material, or when the material level in the second hopper 12 exceed the preset material level and the second hopper 12 is about to be full, the second hopper 12 is stopped from feeding, and the second hopper 12 is switched to the unloading state and the first hopper 11 is changed to continue receiving the sucked material. The first hopper 11 and the second hopper 12 are fed with the material and unloaded in turn, so that the material storage mechanism can continuously maintain the state of the suction operation and achieve high suction efficiency.

Referring to FIGS. 1 and 3, in some embodiments, the material storage mechanism 1 is configured to exhaust gas through a gas outlet 7. The material storage system further includes an outlet gas diverting mechanism 8, and the outlet gas diverting mechanism 8 is arranged on a gas flow path between the material storage mechanism 1 and the gas outlet 7 and is configured to selectively communicate the gas outlet 7 with the first hopper 11 or the second hopper 12, so that the first hopper 11 or the second hopper 12 exhausts gas through the gas outlet 7.

The processor 5 is in signal connection with the outlet gas diverting mechanism 8, and is configured to communicate the gas outlet 7 with the first hopper 11 through the outlet gas diverting mechanism 8 in the first working state of the material storage mechanism 1, so as to form a negative pressure in the first hopper 11, and to communicate the gas outlet 7 with the second hopper 12 through the outlet gas diverting mechanism 8 in the second working state of the material storage mechanism 1, so as to form a negative pressure in the second hopper 12, which is convenient for improving a suction strength.

In the present embodiment, a communication state between the gas outlet 7 and the material storage mechanism 1 may be switched along with a communication state between the feeding port 2 and the material storage mechanism 1. During feeding of the first hopper 11, the gas outlet 7 is switched to be communicated with the first hopper 11, so that a negative pressure suction environment is formed in the first hopper 11, and during feeding of the second hopper 12, the gas outlet 7 is switched to be communicated with the second hopper 12, so that a negative pressure suction environment is formed in the second hopper 12, thereby improving the suction efficiency.

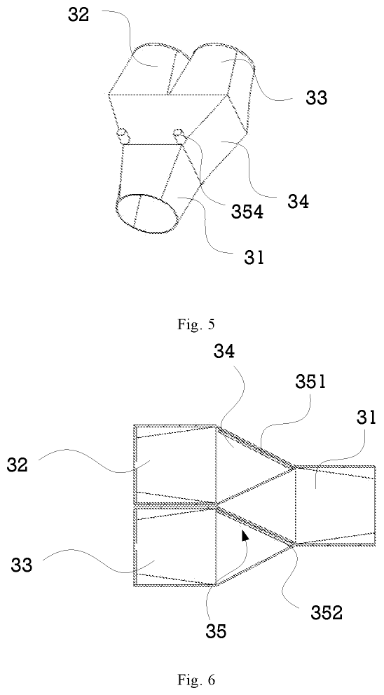

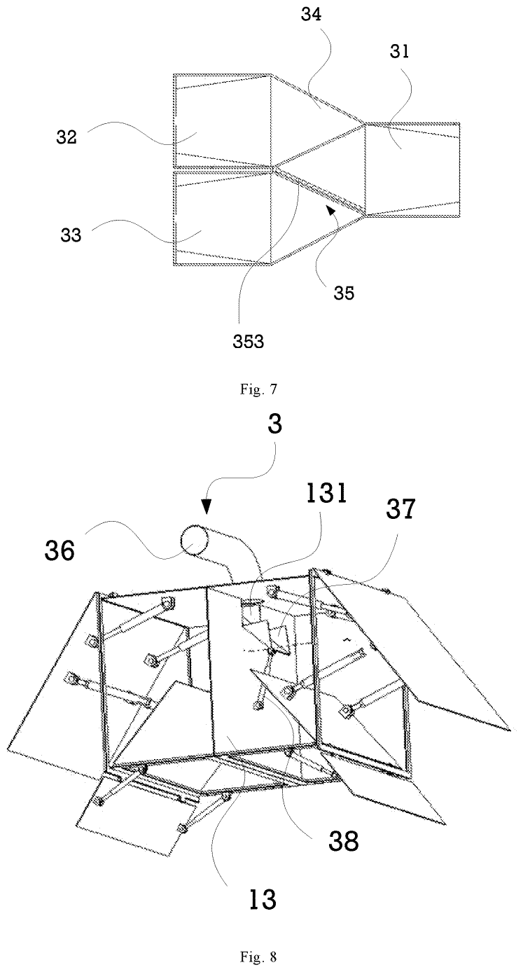

FIG. 5 is a perspective view of the feed distribution mechanism according to some embodiments of the material storage system of the present disclosure, FIG. 6 is a schematic diagram of an internal structure of the feed distribution mechanism according to some embodiments of the material storage system of the present disclosure, and FIG. 7 is a schematic diagram of an internal structure of the feed distribution mechanism according to some other embodiments of the material storage system of the present disclosure. Referring to FIGS. 5-7, in some embodiments, the feed distribution mechanism 3 includes a first feeding portion 31, a first uploading portion 32, a second uploading portion 33, a first shunting portion 34 and a first rotating plate assembly 35. The feed distribution mechanism 3 includes but is not limited to a three-way valve, so that the feeding port is alternatively communicated with the first hopper 11 or the second hopper 12. The first feeding portion 31, the first uploading portion 32, the second uploading portion 33 and the first shunting portion 34 include but are not limited to pipelines or channels.

The first feeding portion 31 is used to be communicated with the feeding port 2, so as to receive the material sucked by the feeding port 2. The first uploading portion 32 is communicated with the first hopper 11, and the first uploading portion 32 is capable of being communicated with the first hopper 11 through a first pipeline 321, so as to guide the material received by the feeding port 2 into the first hopper 11 through the first uploading portion 32 when switching to the first working state. The second uploading portion 33 is communicated with the second hopper 12, and the second uploading portion 33 is capable of being communicated with the second hopper 12 through a second pipeline 331.

The first shunting portion 34 is arranged between the first feeding portion 31 and the first uploading portion 32 and between the first feeding portion 31 and the second uploading portion 33, and is located on the path of the material from the first feeding portion 31 to the first uploading portion 32 and the second uploading portion 33.

On the conveying path of the material from the first feeding portion 31 to the hopper, the first uploading portion 32 and the second uploading portion 33 are capable of being arranged side by side, and are both connected with one side of the first shunting portion 34, and the other side of the first shunting portion 34 is connected with the first feeding portion 31. A cross section of the first shunting portion 34 may be square, so that the first rotating plate assembly 35 is conveniently mounted to realize switching of a communication state. The cross section of one end of the first feeding portion 31 connected with the feeding port 2 may be set to be round, and the cross section of one end of the first feeding portion 31 communicated with the first shunting portion 34 may be set to be square. Ends of the first uploading portion 32 and the second uploading portion 33 connected with the hopper may be set to be round cross sections, and ends of the first uploading portion 32 and the second uploading portion 33 connected with the first shunting portion 34 may be set to be square cross sections.

The first rotating plate assembly 35 is arranged in the first shunting portion 34 and configured to rotate relative to at least one of the first uploading portion 32 and the second uploading portion 33. Referring to FIG. 6, the first rotating plate assembly 35 may include a first rotating plate 351 and a second rotating plate 352. Two rotating plates are arranged in the first shunting portion 34, are located on the flow path between the first shunting portion 34 and the first uploading portion 32 and on the flow path between the first shunting portion 34 and the second uploading portion 33 respectively, and can independently switch on and off states of the two flow paths respectively. The first shunting portion 34 includes but is not limited to a rotating shaft therein, to facilitate the mounting of the first rotating plate assembly 35. Referring to FIG. 7, the first rotating plate assembly 35 may further include a third rotating plate 353, and one rotating plate may be arranged at the position close to the middle of the first shunting portion 34, and rotate to one side close to the first uploading portion 32 or one side close to the second uploading portion 33 respectively, so as to realize the switching of the communication state.

Rotation angle ranges of the first rotating plate 351 and the second rotating plate 352 include but are not limited to 30° to 50°, and a rotation range of the third rotating plate 353 includes but is not limited to 40° to 60°. A sealing frame matched with the first rotating plate assembly 35 may also be arranged in the first shunting portion 34, and a sealing gasket is arranged at the edge of the sealing frame, so as to improve the air tightness when the feeding path is closed.

The processor 5 is in signal connection with the first rotating plate assembly 35, and is configured to control the rotation of the first rotating plate assembly 35, so as to communicate with the first uploading portion 32 to receive the material by the first hopper 11, or communicate the first feeding portion 31 with the second uploading portion 33 to receive the material by the second hopper 12. The material storage system may further include a rotating plate driving member 354, and the rotating plate driving member 354 is in signal connection with the first rotating plate assembly, arranged inside or outside the first shunting portion 34, and connected with the first rotating plate assembly 35, so as to realize adjustment of a rotation angle of the first rotating plate assembly.

In the present embodiment, the feed distribution mechanism 3 may be include the first feeding portion 31, the first uploading portion 32, the second uploading portion 33, the first shunting portion 34 and the first rotating plate assembly 35. By rotating the first rotating plate assembly 35 in the first uploading portion 32, the communication state between the first feeding portion 31 and the first uploading portion 32 or the second uploading portion 33 can be conveniently switched without a need to frequently insert and pull the pipelines, and under the premise of meeting the state switching, the air tightness of the feeding bin can be ensured, and the reliability of the suction operation is improved.

Referring to FIGS. 1-3, in some embodiments, the first hopper 11 is not in communication with the second hopper 12. In the present embodiment, the first hopper 11 and the second hopper 12 are independent to each other, including but not limited to being separated by the partition plate 13 and other structures therebetween in the material storage mechanism 1. The first hopper 11 and the second hopper 12 are not communicated, which can improve the air tightness in their respective bins, so as to form a tighter suction environment and make the suction operation more efficient and reliable.

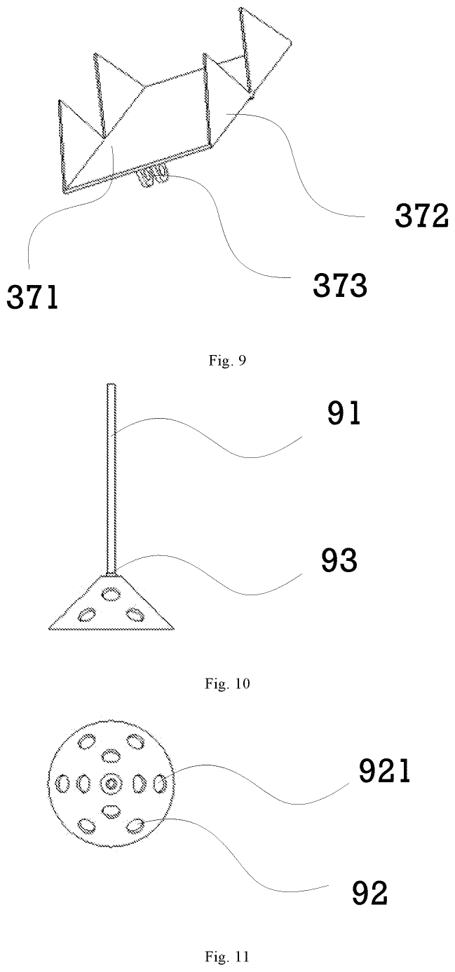

FIG. 8 is a perspective view according to some other embodiments of the material storage system of the present disclosure, and FIG. 9 is a structural schematic diagram of a first flap assembly according to some embodiments of the material storage system of the present disclosure. Referring to FIGS. 8-9, in some embodiments, the first hopper 11 and the second hopper 12 are separated by the partition plate 13 having a mounting hole 131. The feed distribution mechanism 3 includes a second feeding portion 36, a fifth driving member 38 and a first flap assembly 37. The second feeding portion 36 includes but is not limited to a pipeline.

The fifth driving member 38 is arranged between the partition plate 13 and the first flap assembly 37, and the processor 5 is in signal connection with the fifth driving member 38, and is configured to make the first flap assembly 37 turn over to the first hopper 11 through the fifth driving member 38, so that the first hopper 11 receives the material, or is turned over to the second hopper 12, so that the second hopper 12 receives the material.

The second feeding portion 36 is used to be communicated with the feeding port 2 and guide the material received from the feeding port 2 to the first flap assembly 37. The first flap assembly 37 is arranged in the mounting hole 131 and located downstream of the second feeding portion 36. The first flap assembly 37 can be turned over between the first hopper 11 and the second hopper 12 relative to the mounting hole 131 to close the first hopper 11 and guide the material to the second hopper 12, or close the second hopper 12 and guide the material to the first hopper 11.

The first flap assembly 37 includes a flap 371, and the bottom of the flap 371 is provided with a connecting hole 373 so as to be connected with a pin shaft at the mounting hole 131 to turn over the flap 371. A sealing structure 372 may be arranged on the flap 371, and the sealing structure 372 is triangular, so as to close the communication relationship between the other hopper and the mounting hole 131 when the material is guided to one hopper, and improve the air tightness of the material guiding hopper.

In the present embodiment, the feed distribution mechanism 3 may take the form of the second feeding portion 36 and the first flap assembly 37, and the switching of the communication relationship between the feeding port 2 with the first hopper 11 and the second hopper 12 is completed by the rotation of the first flap assembly 37 between the first hopper 11 and the second hopper 12.

Referring to FIGS. 1-3 and 8, in some embodiments, the uploading mechanism 4 includes at least one of a first unloading plate 41 and a second unloading plate 42. The first hopper 11 and the second hopper 12 include but are not limited to rectangular cavity bodies, and the first unloading plate 41 is rotatably connected with the first hopper 11 as a hopper door of the first hopper 11 to open the first hopper 11 for unloading or to close the first hopper 11. It is included but not limited to that the first unloading plate 41 is arranged at the side edge of the first hopper 11, so that the material is unloaded from both sides of the material storage mechanism 1, and a rotating shaft of the first unloading plate 41 may be arranged at the top of the side edge of the first hopper 11. The uploading mechanism 4 and the feeding channel are respectively arranged at different positions of the hopper to prevent an unloading action from interfering with the feeding.

The second unloading plate 42 is rotatably connected with the second hopper 12 as a hopper door of the second hopper 12 to open the second hopper 12 for unloading or to close the second hopper 12. It is included but not limited to that the second unloading plate 42 and the first unloading plate 41 are symmetrically arranged. The first unloading plate 41 is attached to the first hopper 11 in the first working state of the material storage mechanism 1 to close the hopper door of the first hopper 11, so that the first hopper 11 is in a negative pressure suction state. At this time, the second unloading plate 42 may be rotated to the outside of the second hopper 12, thereby opening the second hopper 12, so that the material accumulated in the second hopper 12 are unloaded while the first hopper 11 is being fed, and the suction efficiency of the material storage system is improved.

An outward rotation angle range of the first unloading plate 41 relative to the first hopper 11 includes but is not limited to 0°-80°, and an outward rotation angle range of the second unloading plate 42 relative to the second hopper 12 includes but is not limited to 0°-80°. When the angle is 0°, the first unloading plate 41 closes the first hopper 11 and the second unloading plate 42 closes the second hopper 12. The hopper doors of the first hopper 11 and the second hopper 12 may be respectively provided with sealing gaskets to be matched with the first unloading plate 41 and the second unloading plate 42 for sealing.

In the present embodiment, the uploading mechanism 4 may include the unloading plates which are capable of being opened and closed relative to the hoppers, and in cooperation with the working state of the material storage mechanism 1, the unloading operation is performed in one hopper while the other hopper sucks the material for feeding, which can accelerate the suction operation efficiency of the material storage system.

Referring to FIGS. 1-3 and 8, in some embodiments, the uploading mechanism 4 further includes at least one of a first driving member 411 and a second driving member 421. The first driving member 411 is connected between the inner wall of the first hopper 11 and the first unloading plate 41, and the second driving member 421 is connected between the inner wall of the second hopper 12 and the second unloading plate 42.

The processor 5 is in signal connection with at least one of the first driving member 411 and the second driving member 421, and is configured to open the first hopper 11 or the second hopper 12 through at least one of the first driving member 411 and the second driving member 421, so that the first hopper 11 or the second hopper 12 unloads the material.

In the present embodiment, by arranging at least one of the first driving member 411 and the second driving member 421, the working state of the unloading plate can be switched according to a change of the material level in the hopper, so that the material storage system realizes the material storage and unloading simultaneously, and the practicability is improved.

Referring to FIGS. 1-3 and 8, in some embodiments, the uploading mechanism 4 further includes at least one of a first material pushing plate 43 and a second material pushing plate 44. As a bottom plate of the first hopper 11, the first material pushing plate 43 is rotatably connected with the first hopper 11, so as to rotate from the bottom of the first hopper 11 to a direction outside the first hopper 11, and drive the material carried on the surface of the first hopper 11 to rotate outward along with the first hopper 11, so that the material in the first hopper 11 are pushed out through the hopper door of the first hopper 11, and the hopper door includes but is not limited to the hopper door where the first unloading plate 41 is mounted. As a bottom plate of the second hopper 12, the second material pushing plate 44 is rotatably connected with the second hopper 12, so that the material in the second hopper 12 are pushed out through the hopper door of the second hopper 12.

A rotation angle range of the first material pushing plate 43 relative to the bottom of the first hopper 11 is 0°-80°, and a rotation angle range of the second material pushing plate 44 relative to the bottom of the second hopper 12 is 0°-80°. When the rotation angle is 0°, the first material pushing plate 43 closes the bottom of the first hopper 11 and the second material pushing plate 44 closes the bottom of the second hopper 12. The bottoms of the first hopper 11 and the second hopper 12 may also be provided with sealing gaskets respectively to be matched with the first material pushing plate 43 and the second material pushing plate 44, so as to improve a sealing degree.

In the present embodiment, by arranging at least one of the first material pushing plate 43 and the second material pushing plate 44 and rotating the first material pushing plate 43 and the second material pushing plate 44, it is helpful for the material to move out of the hoppers along the material pushing plates under actions of the inclined material pushing plates, and the unloading efficiency is improved.

Referring to FIGS. 1-3 and 8, in some embodiments, the material storage system configured to be at least one of the following: the first material pushing plate 43 and the first unloading plate 41 are connected by a first connector 431, and the first material pushing plate 43 is configured to rotate along with the rotation of the first unloading plate 41; wherein the second material pushing plate 44 and the second unloading plate 42 are connected by a second connector 441, and the second material pushing plate 44 is configured to rotate along with the rotation of the second unloading plate 42.

In the present embodiment, by arranging the first connector 431 and the second connector 441, the first material pushing plate 43 may be linked with the first unloading plate 41, and the second material pushing plate 44 may be linked with the second unloading plate 42, so that the unloading operation is more efficient.

Referring to FIGS. 1-3 and 8, in some embodiments, the material storage system configured to be at least one of the following: a length of the first connector 431 is adjustable, so that when the first unloading plate 41 is in the position of closing the hopper door of the first hopper 11, the first material pushing plate 43 closes the bottom of the first hopper 11; and a length of the second connector 441 is adjustable, so that when the second unloading plate 42 closes the hopper door of the second hopper 12, the second material pushing plate 44 closes the bottom of the second hopper 12.

The first connector 431 and the second connector 441 include but are not limited to screw rods, including two screw rods with positive and negative threads. By rotating a connecting screw rod in the middle, the screw rods at both ends may be extended or shortened at the same time, or the length of one of the screw rods may be adjusted independently. When adjusted properly, the length is locked by a locking nut to avoid the change during use.

The uploading mechanism 4 may further include a proximity switch for detecting whether the first material pushing plate 43, the first unloading plate 41, the second material pushing plate 44 and the second unloading plate 42 form a proper seal in place.

In the present embodiment, by adjusting the lengths of the first connector 431 and the second connector 441, when the unloading plates are in the state of closing the hopper doors, the material pushing plates can also close the bottoms of the hoppers, thereby achieving better sealing performance.

Referring to FIGS. 1-3 and 8, in some embodiments, the uploading mechanism 4 further includes at least one of a first material guiding plate 45 and a second material guiding plate 46. The first material guiding plate 45 is arranged outside the first hopper 11, rotatably connected with the bottom of the first hopper 11, and configured to guide the material in the first hopper 11 to be unloaded along the first material guiding plate 45.

The second material guiding plate 46 is arranged outside the second hopper 12, rotatably connected with the bottom of the second hopper 12, and configured to guide the material in the second hopper 12 to be unloaded along the second material guiding plate 46.

The range of an included angle between the first material guiding plate 45 and the vertical direction is 0°-60°, and the range of an included angle between the second material guiding plate 46 and the vertical direction is 0°-60°. When the included angle is 0°, the first material guiding plate 45 and the second material guiding plate 46 are parallel to the vertical direction and are in a non-unloading state. When unloading is needed, the material guiding plates may be rotated to a suitable angle first, and then the unloading plates and the material pushing plates are rotated until the material are unloaded from side edges of the hoppers.

In the present embodiment, by arranging at least one of the first material guiding plate 45 and the second material guiding plate 46, the material can be guided to move to the side edge of the material storage mechanism 1 when the material are unloaded, and the risk that the material fall to the bottom of the material storage mechanism 1 and affect the movement and walking of the suction device is reduced.

Referring to FIGS. 1-3 and 8, in some embodiments, the uploading mechanism 4 further includes at least one of a third driving member 451 and a fourth driving member 461. The third driving member 451 is connected between the bottom of the first hopper 11 and the first material guiding plate 45, and the fourth driving member 461 is connected between the bottom of the second hopper 12 and the second material guiding plate 46.

The processor 5 is in signal connection with the third driving member 451 and the fourth driving member 461, and is configured to switch a material guiding angle of the first material guiding plate 45 through the third driving member 451 and switch a material guiding angle of the second material guiding plate 46 through the fourth driving member 461. The first driving member 411, the second driving member 421, the third driving member 451 and the fourth driving member 461 include but are not limited to oil cylinders.

In the present embodiment, due to the arrangement of the third driving member 451 and the fourth driving member 461, it is convenient to adjust the rotation angles of the material guiding plates according to the size of the material storage mechanism 1 or the material storage device and an unloading situation, so as to guide the material to fall to preset positions.

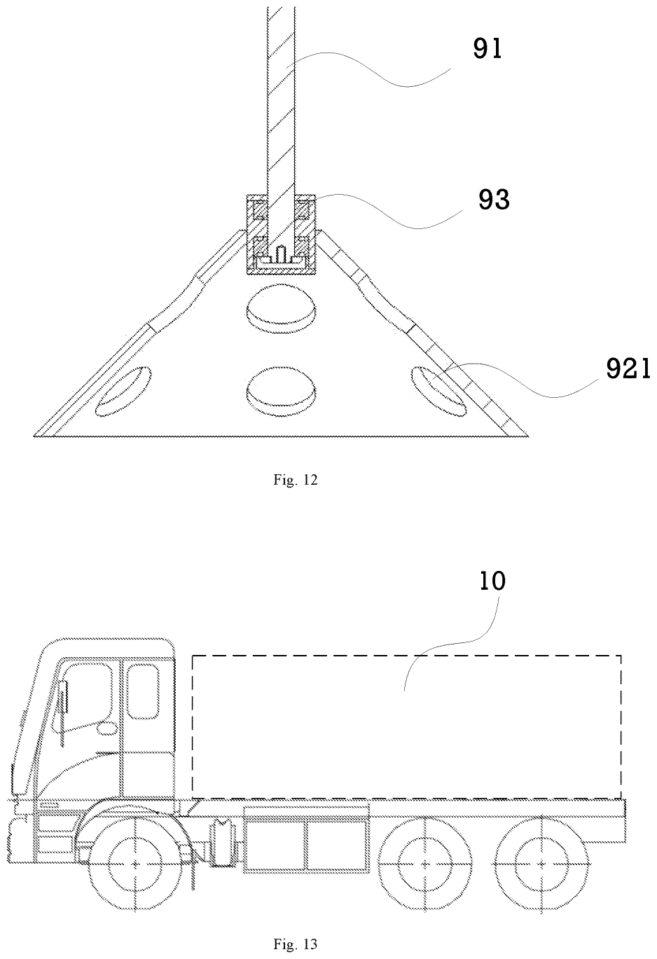

FIG. 10 is a structural perspective view of a material dispersion mechanism according to some embodiments of the material storage system of the present disclosure, FIG. 11 is a top view of the material dispersion mechanism according to some embodiments of the material storage system of the present disclosure, and FIG. 12 is a cross-sectional view of the material dispersion mechanism according to some embodiments of the material storage system of the present disclosure. Referring to FIGS. 10-12, in some embodiments, the material storage system further includes a material dispersion mechanism 9. The material dispersion mechanism 9 is arranged in the material storage mechanism 1 and has a mounting portion 91 and a rotating portion 92. The mounting portion 91 is connected with the material storage mechanism 1, the rotating portion 92 is rotatably connected with the mounting portion 91, and the surface of the rotating portion 92 has a plurality of blanking holes 921 arranged at intervals. The material dispersion mechanism 9 is configured to enable the material from the feeding port 2 to fall dispersedly in the material storage mechanism 1.

The material dispersion mechanism 9 may be arranged at the joint between the top of the hopper and at least one of the first pipeline 321 and the second pipeline 331, a bearing 93 is arranged outside the mounting portion 91, and the rotating portion 92 is connected with the mounting portion 91 through the bearing 93 so as to rotate around the mounting portion 91. The mounting portion 91 may be a steel rod or a flexible structure such as a chain, and the rotating portion 92 can rotate and swing.

The rotating portion 92 has a conical shape, a cone angle is 60°-135°, and a diameter of the blanking hole 921 is ⅛-⅓ of an opening diameter of the rotating portion 92, so that the rotating portion 92 not only can realize a flow guiding function, but also will not hinder the feeding and prevent the material from sticking to the sidewalls of the hoppers, so that the material can be evenly distributed at the bottoms of the hoppers. After the material enter the hoppers, under the action of the material dispersion mechanism 9, portion of the material directly falls from the blanking holes 921, and the other portion may fall along an inclined plane of the rotating portion 92. The rotating portion 92 may also adopt an irregular conical structure.

In the present embodiment, by arranging the material dispersion mechanism 9, the material can be more evenly distributed in the hoppers through at least one of rotation and swinging of the rotating portion 92.

In some embodiments, the outlet gas diverting mechanism 8 includes a first gas outlet portion, a first gas inlet portion, a second gas inlet portion, a second shunting portion and a second rotating plate assembly.

The first gas outlet portion is used to be communicated with the gas outlet 7, the first gas inlet portion is communicated with the first hopper 11, the second gas inlet portion is communicated with the second hopper 12, the second shunting portion is arranged between the first gas outlet portion and the first gas inlet portion and between the first gas outlet portion and the second gas inlet portion, and the second rotating plate assembly is arranged in the second shunting portion and can rotate relative to at least one of the first gas inlet portion and the second gas inlet portion.

The processor 5 is in signal connection with the second rotating plate assembly, and is configured to enable the first gas outlet portion to be communicated with the first gas inlet portion by switching a rotating state of the second rotating plate assembly, so that the gas in the first hopper is exhausted through the first gas inlet and the first gas outlet portion, or the first gas outlet portion is enabled to be communicated with the second gas inlet, so that the gas in the second hopper is exhausted through the second gas inlet and the first gas outlet portion.

In the present embodiment, the outlet gas diverting mechanism 8 may be in a structural form similar to the feed distribution mechanism 3, so as to be matched with the feeding state of the first hopper 11 and the second hopper 12, provide a negative pressure for the hoppers, and improve the suction efficiency.

FIG. 13 is a schematic structural diagram according to some embodiments of a suction device of the present disclosure. In another aspect of the embodiments of the present disclosure, a suction device is provided and includes any material storage system 10 as described above. The suction device includes but is not limited to a dredging truck, a digging suction truck, a rescue suction unit, etc., which are used in emergency rescue occasions such as geological disasters, or occasions such as nondestructive excavation of underground pipelines in the municipal field and dredging of underground limited spaces.

In the present embodiment, by using the material storage system 10, the suction device can enable the material storage operation and the unloading operation to be performed independently and simultaneously in different hoppers, which is helpful to greatly improve the suction efficiency and save the rescue time.

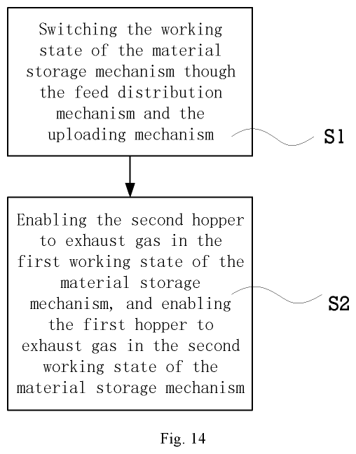

FIG. 14 is a flowchart according to some embodiments of a control method for a material storage system of the present disclosure. Referring to FIG. 14, in yet another aspect of the embodiments of the present disclosure, a control method for a material storage system based on any material storage system described above is provided and includes step S1. Step S1 may be realized by the processor 5 executing instructions.

In step S1, switching the material storage mechanism 1 between the first working state and the second working state by the feed distribution mechanism 3 and the uploading mechanism 4. In the first working state of the material storage mechanism 1, the material storage mechanism 1 receives the material through the first hopper 11 and unloads the material through the second hopper 12, and in the second working state of the material storage mechanism 1, the material storage mechanism 1 receives the material through the second hopper 12 and unloads the material through the first hopper 11.

In the present embodiment, the material storage mechanism 1 is switched between the first working state and the second working state through the feed distribution mechanism 3 and the uploading mechanism 4, so that the material storage operation and the unloading operation can be independently and simultaneously carried out in different hoppers, which is helpful to greatly improve the suction efficiency.

In some embodiments, the material storage system further includes the material level detection mechanism 6. The material level detection mechanism 6 is arranged at the material storage mechanism 1 and configured to obtain material level in the first hopper 11 and the second hopper 12.

The operation of switching the material storage mechanism 1 between the first working state and the second working state through the feed distribution mechanism 3 and the uploading mechanism 4 specifically includes: obtaining the material levels in the first hopper 11 and the second hopper 12 through the material level detection mechanism 6, switching the material storage mechanism 1 to the second working state in response to the material level in the first hopper 11 being greater than a preset material level, and switching the material storage mechanism 1 to the first working state in response to the material level in the second hopper 12 being greater than the preset material level.

In the present embodiment, by monitoring the material level in the hopper in real time, when the material level in the hopper is full, the hopper may be switched to the unloading state, the other hopper is switched to the material storage operation, and the first hopper 11 and the second hopper 12 are fed with the material and unloaded in turn, so that the material storage mechanism can continuously maintain a suction operation state and achieve higher suction efficiency.

Referring to FIG. 14, in some embodiments, the material storage mechanism 1 is configured to exhaust gas through the gas outlet 7. The material storage system further includes the outlet gas diverting mechanism 8, which is arranged on the gas flow path between the material storage mechanism 1 and the gas outlet 7 and is configured to selectively communicate the gas outlet 7 with the first hopper 11 or the gas outlet 7 with the second hopper 12, so that the first hopper 11 or the second hopper 12 exhausts gas through the gas outlet 7.

Accordingly, the control method for a material storage system may further include step S2. Step S2 may be realized by the processor 5 executing instructions.

In step S2, in the first working state of the material storage mechanism 1, communicating the gas outlet 7 with the first hopper 11 through the outlet gas diverting mechanism 8, so that a negative pressure is formed in the first hopper 11; and in the second working state of the material storage mechanism 1, communicating the gas outlet 7 with the second hopper 12 through the outlet gas diverting mechanism 8, so that a negative pressure is formed in the second hopper 12.

In the present embodiment, during feeding of the first hopper 11, the gas outlet 7 is switched to be communicated with the first hopper 11, so that a negative pressure suction environment is formed in the first hopper 11, and during feeding of the second hopper 12, the gas outlet 7 is switched to be communicated with the second hopper 12, so that a negative pressure suction environment is formed in the second hopper 12, thereby improving the suction efficiency.

A control flow of the material storage system in some embodiments is given as follows: when the material enter from the feeding port 2, first, open the rotating plate on one side of the feed distribution mechanism 3, close the rotating plate on the other side, and open and close the corresponding rotating plate of the outlet gas diverting mechanism 8, and the material fall uniformly in one of the hoppers under the action of the material dispersion mechanism 9. When a material level sensor at the top of the hopper detects that the material in the hopper have reached a set volume, it will give a prompt for switching the hopper and unloading, then open the rotating plate corresponding to the other hopper first, and then close the rotating plate corresponding to the hopper filled with the material. Open the rotating plate on the side of the gas outlet 7 first while performing the operation to open the rotating plate, then open the rotating plate on the side of the feeding port 2. Close the rotating plate on the side of the feeding port 2 is first closed while performing the operation to close the rotating plate, then by rotating the unloading plate to a proper angle, rotate the material pushing plate and the material guiding plate until the material are completely unloaded, next, reset the unloading plate and the material pushing plate, then detect the reset situation by the proximity switch, and finally reset the material guiding plate. When the other hopper is full of the material, the hopper is switched in a similar way and order for unloading.

So far, various embodiments of the present disclosure have been described in detail. In order to avoid obscuring concepts of the present disclosure, some details that are well known in the art have not been described. Those skilled in the art can fully understand how to implement the technical solutions disclosed here according to the above descriptions.

Although some specific embodiments of the present disclosure have been described in detail through examples, it should be understood by those skilled in the art that the above examples are only for illustration and are not intended to limit the scope of the present disclosure. Those skilled in the art should understand that the above embodiments can be modified, or some technical features can be replaced by equivalents without departing from the scope and spirit of the present disclosure. The scope of the present disclosure is defined by appended claims.

1. A material storage system for a suction device, comprising:
a material storage mechanism, having a first hopper and a second hopper, and the material storage mechanism configured to receive material through a feeding port;
a feed distribution mechanism, arranged on a material conveying path between the material storage mechanism and the feeding port, and being configured to selectively communicate the feeding port with the first hopper or the second hopper, so that the first hopper or the second hopper receives material through the feeding port;
an uploading mechanism, operatively connected with the first hopper and the second hopper, and being configured to selectively switch between an opening of the first hopper and an opening of the second hopper, so that the first hopper or the second hopper is capable of uploading material; and
a processor, in signal connection with the feed distribution mechanism and the uploading mechanism, and being configured to switch the material storage mechanism between a first working state and a second working state through the feed distribution mechanism and the uploading mechanism so that in the first working state of the material storage mechanism, the material storage mechanism configured to receive material through the first hopper and unload material through the second hopper, and in the second working state of the material storage mechanism, the material storage mechanism configured to receive material through the second hopper and unload material through the first hopper.

2. The material storage system according to claim 1, further comprising:
a material level detection mechanism, arranged in the material storage mechanism and being configured to obtain a material level in the first hopper and the second hopper;
wherein the processor is in signal connection with the material level detection mechanism and configured to operate the material storage mechanism in the first working state or the second working state according to at least one of the material level of the first hopper and the material level of the second hopper.

3. The material storage system according to claim 1, wherein the material storage mechanism configured to exhaust gas through a gas outlet;
wherein the material storage system further comprises:
an outlet gas diverting mechanism, arranged on a gas flow path between the material storage mechanism and the gas outlet, and being configured to selectively communicate the gas outlet with the first hopper or the second hopper, so that the first hopper or the second hopper is configured to exhaust gas through the gas outlet;
wherein the processor is in signal connection with the outlet gas diverting mechanism, and is configured to communicate the gas outlet with the first hopper through the outlet gas diverting mechanism in the first working state of the material storage mechanism, so as to form a negative pressure in the first hopper, and to communicate the gas outlet with the second hopper through the outlet gas diverting mechanism in the second working state of the material storage mechanism, so as to form a negative pressure in the second hopper.

4. The material storage system according to claim 1, wherein the feed distribution mechanism comprises:
a first feeding portion, for being communicated with the feeding port;
a first uploading portion, communicated with the first hopper;
a second uploading portion, communicated with the second hopper;
a first shunting portion, arranged between the first feeding portion and the first uploading portion and between the first feeding portion and the second uploading portion; and
a first rotating plate assembly, arranged in the first shunting portion and configured to rotate relative to at least one of the first uploading portion and the second uploading portion;
wherein the processor is in signal connection with the first rotating plate assembly, and is configured to control the rotation of the first rotating plate assembly, so as to communicate the first feeding portion with the first uploading portion to receive the material by the first hopper, or communicate the first feeding portion with the second uploading portion to receive the material by the second hopper.

5. The material storage system according to claim 1, wherein the first hopper is not in communication with the second hopper.

6. The material storage system according to claim 5, wherein the first hopper and the second hopper are separated by a partition plate (13)-with a mounting hole;
wherein the feed distribution mechanism comprises:
a second feeding portion, communicating with the feeding port;
a first flap assembly, arranged at the mounting hole, located downstream of the second feeding portion, and the first flap assembly configured to turn over between the first hopper and the second hopper relative to the mounting hole to close the first hopper and guide the material to the second hopper, or close the second hopper and guide the material to the first hopper; and
a fifth driving member, arranged between the partition plate and the first flap assembly;
wherein the processor is in signal connection with the fifth driving member, and is configured to make the first flap assembly turn over to the first hopper through the fifth driving member, so that the first hopper receives the material, or is turned over to the second hopper, so that the second hopper receives the material.

7. The material storage system according to claim 1, wherein the uploading mechanism comprises at least one of:
a first unloading plate, rotatably connected with the first hopper as a hopper door of the first hopper, to open the first hopper for unloading the first hopper or closing the first hopper; and
a second unloading plate, rotatably connected with the second hopper as a hopper door of the second hopper, to open the second hopper for unloading the second hopper or closing the second hopper.

8. The material storage system according to claim 7, wherein the uploading mechanism further comprises at least one of the following:
a first driving member, connected between an inner wall of the first hopper and the first unloading plate; and
a second driving member, connected between an inner wall of the second hopper and the second unloading plate;
wherein the processor is in signal connection with at least one of the first driving member and the second driving member, and is configured to open the first hopper or the second hopper through at least one of the first driving member and the second driving member, so that the first hopper or the second hopper unloads the material.

9. The material storage system according to claim 7, wherein the uploading mechanism further comprises at least one of the following:
a first material pushing plate, rotatably connected with the first hopper as a bottom plate of the first hopper, so as to push the material in the first hopper out of the first hopper; and
a second material pushing plate, rotatably connected with the second hopper as a bottom plate of the second hopper, so as to push the material in the second hopper out of the second hopper.

10. The material storage system according to claim 9, wherein the material storage system configured to be at least one of the following:
the first material pushing plate and the first unloading plate are connected by a first connector, and the first material pushing plate is configured to rotate along with rotation of the first unloading plate; and
the second material pushing plate and the second unloading plate are connected by a second connector, and the second material pushing plate is configured to rotate along with rotation of the second unloading plate.

11. The material storage system according to claim 10, wherein the material storage system configured to be at least one of the following:
a length of the first connector is adjustable, so that when the first unloading plate is in a position of closing the hopper door of the first hopper, the first material pushing plate closes the bottom of the first hopper; and
a length of the second connector is adjustable, so that when the second unloading plate closes the hopper door of the second hopper, the second material pushing plate closes the bottom of the second hopper.

12. The material storage system according to claim 7, wherein the uploading mechanism further comprises at least one of the following:
a first material guiding plate, arranged at an outer side of the first hopper, rotatably connected with the bottom of the first hopper, and being configured to guide the material in the first hopper to be unloaded along the first material guiding plate; and
a second material guiding plate, arranged at an outer side of the second hopper, rotatably connected with the bottom of the second hopper, and being configured to guide the material in the second hopper to be unloaded along the second material guiding plate.

13. The material storage system according to claim 12, wherein the uploading mechanism further comprises at least one of the following:
a third driving member, connected between the bottom of the first hopper and the first material guiding plate; and
a fourth driving member, connected between the bottom of the second hopper and the second material guiding plate;
wherein the processor is in signal connection with the third driving member and the fourth driving member, and is configured to switch a material guiding angle of the first material guiding plate through the third driving member and a material guiding angle of the second material guiding plate through the fourth driving member.

14. The material storage system according to claim 1, further comprising:
a material dispersion mechanism, arranged in the material storage mechanism, and having a mounting portion and a rotating portion, wherein the mounting portion is connected with the material storage mechanism, the rotating portion is rotatably connected with the mounting portion, the rotating portion has a plurality of blanking holes arranged at intervals, and the material dispersion mechanism is configured to enable the material from the feeding port to fall dispersedly in the material storage mechanism.

15. A suction apparatus, comprising:
a material storage system comprising:
a material storage mechanism, having a first hopper and a second hopper, and the material storage mechanism configured to receive material through a feeding port;
a feed distribution mechanism, arranged on a material conveying path between the material storage mechanism and the feeding port, and being configured to selectively communicate the feeding port with the first hopper or the second hopper, so that the first hopper or the second hopper receives material through the feeding port;
an uploading mechanism, operatively connected with the first hopper and the second hopper, and being configured to selectively switch between an opening of the first hopper and an opening of the second hopper, so that the first hopper or the second hopper is capable of uploading material; and
a processor, in signal connection with the feed distribution mechanism and the uploading mechanism, and being configured to switch the material storage mechanism between a first working state and a second working state through the feed distribution mechanism and the uploading mechanism, so that in the first working state of the material storage mechanism, the material storage mechanism configured to receive material through the first hopper and unload material through the second hopper, and in the second working state of the material storage mechanism, the material storage mechanism configured to receive material through the second hopper and unload material through the first hopper.

16. A control method for a material storage system comprising:
a material storage mechanism, having a first hopper and a second hopper, and the material storage mechanism configured to receive material through a feeding port;
a feed distribution mechanism, arranged on a material conveying path between the material storage mechanism and the feeding port, and being configured to selectively communicate the feeding port with the first hopper or the second hopper, so that the first hopper or the second hopper receives material through the feeding port;
an uploading mechanism, operatively connected with the first hopper and the second hopper, and being configured to selectively switch between an opening of the first hopper and an opening of the second hopper, so that the first hopper or the second hopper is capable of uploading material; and
a processor, in signal connection with the feed distribution mechanism and the uploading mechanism, and being configured to switch the material storage mechanism between a first working state and a second working state through the feed distribution mechanism and the uploading mechanism, so that in the first working state of the material storage mechanism, the material storage mechanism configured to receive material through the first hopper and unload material through the second hopper, and in the second working state of the material storage mechanism, the material storage mechanism configured to receive material through the second hopper and unload material through the first hopper;
the control method comprising:
switching the material storage mechanism between the first working state and the second working state through the feed distribution mechanism and the uploading mechanism;
wherein in the first working state of the material storage mechanism, the material storage mechanism receives material through the first hopper and unloads the material through the second hopper, and in the second working state of the material storage mechanism, the material storage mechanism receives the material through the second hopper and unloads the material through the first hopper.

17. The control method for the material storage system according to claim 16, wherein the material storage system further comprises:
a material level detection mechanism, arranged at the material storage mechanism and configured to obtain a material level in the first hopper and the second hopper;
wherein the operation of switching the material storage mechanism between the first working state and the second working state through the feed distribution mechanism and the uploading mechanism specifically comprises:
obtaining the material level in the first hopper and the material level in the second hopper through the material level detection mechanism; and
in response to the material level in the first hopper being greater than a preset material level, switching the material storage mechanism to the second working state, and in response to the material level in the second hopper being greater than the preset material level, switching the material storage mechanism to the first working state.

18. The control method for the material storage system according to claim 16, wherein the material storage mechanism is configured to exhaust gas through a gas outlet;
wherein the material storage system further comprises:
an outlet gas diverting mechanism, arranged on a gas flow path between the material storage mechanism and the gas outlet, and being configured to selectively communicate the gas outlet with the first hopper or the gas outlet with the second hopper, so that the first hopper or the second hopper exhausts gas through the gas outlet;
wherein the control method for a material storage system further comprises:
in the first working state of the material storage mechanism, communicating the gas outlet with the first hopper through the outlet gas diverting mechanism, so that a negative pressure is formed in the first hopper, and in the second working state of the material storage mechanism, communicating the gas outlet with the second hopper through the outlet gas diverting mechanism, so that a negative pressure is formed in the second hopper.
